(19) United States
(12) Patent Application Publication
(10) Pub. No.: US 2017/0134243 A1
(43) Pub. Date: May 11, 2017

(54) DATA AUGMENTATION PIPELINE FOR AUGMENTING EVENTS AND/OR DATA ASSOCIATED WITH EVENTS

(71) Applicant: CENX, Inc., Ottawa (CA)

(72) Inventors: Simon B. LÉVESQUE, Ottawa (CA); Andrew Joseph TARZWELL, Ottawa (CA); Eric Duncan SOUTAR, Ottawa (CA)

(21) Appl. No.: 14/933,604

(22) Filed: Nov. 5, 2015

(51) Int. Cl. H04L 12/24; H04L 12/26

(52) U.S. Cl. CPC H04L 41/20; H04L 41/22; H04L 43/04

(57) ABSTRACT

Disclosed herein are system, apparatus, article of manufacture, method, and/or computer program product embodiments for providing a data augmentation pipeline for augmenting events and/or data associated with events. An embodiment, operates by receiving one or more events from one or more service systems, where each event may include an event context, processing the one or more events by one or more augmentation components of a data augmentation pipeline for augmentation based on the event context associated with each event, and enqueuing the one or more processed events into one or more output queues.

### FIELD

This disclosure is generally related to the data augmentation pipeline, and more specifically providing a data augmentation pipeline for augmenting events and/or data associated with events.

### BACKGROUND

Network data usage has increased rapidly in recent years. Network service users demand higher bandwidth with better quality and secure connectivity. Modern network service providers operate local, regional, and nationwide networks to provide connectivity to users. These networks are built with a variety of equipment to perform various tasks, and such equipment may be manufactured by multiple vendors. Each piece of equipment may be complex enough to handle hundreds to thousands of simultaneous connections, and different pieces of equipment may be widely dispersed across a region. Wireless base stations, for example, may be geographically distributed across a city to optimize coverage and efficiency.

To meet user demand, network operators are investing heavily in network infrastructure and new applications to increase network capacity and maintain consistent performance. Today's network infrastructure is evolving faster than ever due to significant innovations in high-speed mobile broadband, cloud-based applications, network functions virtualization (NFV), software-defined networking (SDN), carrier Ethernet, and IP virtual private networks (VPNs). These advances in network technologies are impacting the underlying networks upon all network service providers. Service providers introduce 4G technology, cloud-based infrastructure, NFV, and SDN to better scale and manage their services and infrastructure assets. These dynamics have been fueling a transformation from TDM-based bandwidth services to carrier Ethernet and layer 3 IP services such as IP-VPN and Multiprotocol Label Switching (MPLS) connectivity.

For example, NFV and SDN are two emerging technologies that are expanding the transformation of service provider network services. NFV uses virtualization technologies to design, deploy, and manage network services. NFV decouples the network functions, such as firewall, network address translation (NAT), domain name service (DNS), load balancing, WAN optimization, and intrusion detection, from dedicated hardware appliances so that these network functions can execute in software and processes running within virtual machines. SDN separates control and forwarding functions, centralizes management, and programs network behavior using well-defined interfaces. SDN enables network control to become directly programmable, and the underlying infrastructure can be abstracted from applications and network services. With SDN and NFV, service providers can provide differentiated, revenue-generating service offerings to their end customers while reducing operational costs and simplifying network management.

Another extension is Voice over Long Term Evolution (VoLTE), which allows service providers to offer voice communication services over their high speed 4G LTE infrastructures that was traditionally used for data only, maximizing the value of service providers' investment. VoLTE is moving into mainstream production globally. As service providers are deploying VoLTE, service providers are also leveraging NFV technology to build out their VoLTE infrastructure more efficiently and cost effectively.

These disruptive technologies lead to significant challenges for network service providers because network transformation is complex and labor-intensive. Service providers need to build out network infrastructure leveraging emerging technologies while also operating within their existing infrastructure and maintaining the high quality of service end users expect.

Accommodating new technologies can increase the complexity of network operations. The increased operational complexity may include, for example, lengthy circuit turn-up time, inventory inaccuracy, challenges in accurately resolving faults, or unreliable performance for high value applications such as video and VoLTE. To handler this complexity, today's mobile, wire line, and cloud data center service providers are looking for new ways to design, implement, and manage their network infrastructures.

Conventional operations support systems (OSSs) are systems used by service providers to manage their networks (e.g., telephone networks or data networks) with a variety of existing models. But conventional OSSs can no longer simply be tweaked to support end-to-end management of increasingly complex network infrastructures.

Modern communications carriers operate local, regional, and nationwide networks to provide connectivity to customers. These networks are built with a variety of equipment to perform various tasks, and such equipment may be manufactured by multiple vendors. Each piece of equipment may be complex enough to handle hundreds or thousands of simultaneous connections, and different pieces of equipment may be widely dispersed across a region. Wireless base stations, for example, are geographically distributed across a city to optimize coverage and efficiency. Customer expectations of network availability, given such distribution, complexity, and heterogeneity of equipment, mandate fast detection and accurate diagnosis of network issues that may arise. Existing OSSs models do not accommodate the needs of these complex networks. There is little abstraction to hide the complexity, and each OSS needs to hold the detailed physical inventory and logical service topology in every domain across all legacy and new technologies.

To address network issues and ensure availability, network operators must be able to monitor elements and resources within the network.

### BRIEF SUMMARY

Provided herein are system, apparatus, article of manufacture, method, and/or computer program product embodiments, and/or combinations and sub-combinations thereof, for providing a data augmentation pipeline for augmenting events and/or data associated with events.

An embodiment includes a computer implemented method for providing a data augmentation pipeline for augmenting events and/or data associated with events. The method may receive one or more events from one or more service systems, the one or more events including a first event, where the first event may include a first event context having an associated first element identifier. The method may further process the first event by a first augmentation component of a data augmentation pipeline for augmentation based on the first event context of the first event and enqueue the first event into at least one output queue, after processing the first event by the data augmentation pipeline.

Another embodiment includes a system for providing a data augmentation pipeline for augmenting events and/or data associated with events. The system may include at least one processor and a memory operatively coupled to the at least one processor, the memory comprising instructions that, when executed by the at least one processor, configures the at least one processor to receive one or more events from one or more service systems, where each event may include an event context. The at least one processor may be further configured to process the one or more events by one or more augmentation components of a data augmentation pipeline for augmentation based on the event context of each event, and enqueue the one or more processed events into one or more output queues.

A further embodiment includes a tangible computer-readable device having instructions stored thereon that, when executed by at least one computing device, causes the at least one computing device to perform operations. The operations may include receiving one or more events from one or more service systems, where the one or more events may include a first event, the first event may further include a first event context having an associated first element identifier, processing the first event by a first augmentation component of a data augmentation pipeline for augmentation based on the first event context of the first event, and enqueuing the first event into at least one output queue, after processing the first event by the data augmentation pipeline.

Further embodiments, features, and advantages of the invention, as well as the structure and operation of the various embodiments, are described in detail below with reference to accompanying drawings.

### BRIEF DESCRIPTION OF THE DRAWINGS

The accompanying drawings, which are incorporated herein and form part of the specification, illustrate the present disclosure and, together with the description, further serve to explain the principles of the disclosure and to enable a person skilled in the relevant art to make and use the disclosure.

FIG. 1 illustrates a data augmentation system, according to an example embodiment.

FIG. 2 illustrates a data augmentation application, search platform datastore, and queuing device, according to an example embodiment.

FIG. 3 illustrates the queuing application and the data augmentation pipeline according to an example embodiment.

FIG. 4 illustrates a flowchart of the data augmentation system, according to an example embodiment.

FIG. 5 is a diagram illustrating an example computing device, according to an example embodiment.

Like reference numerals refer to corresponding parts throughout the several views of the drawings. Additionally, generally, the left-most digit(s) of a reference number identifies the drawing in which the reference number first appears.

### DETAILED DESCRIPTION

### Overview

To ensure reliability and availability of a telecommunications network, network objects and resources must be closely monitored, and issues must be quickly diagnosed and corrected. A network operator of a customer or a client may operate an interactive, graphical user interface provided by a user interface (UI) system to a client device in order to enable the network operator to view and analyze data related to one or more network elements in telecommunications network.

In order to provide the latest information regarding various aspects of a customer's or a client's telecommunications network, one or more event producers. The one or more event producers may further include one or more service systems, where the one or more service systems may be configured to generate one or more events, in response to one or more updates associated with the one or more network elements. The generated events may then be consumed by one or more event consumers. The one or more event consumers may also include the one or more service systems configured to facilitate the monitoring and/or updating of the one or more network elements of the customer's or a client's telecommunications network based on the one or more generated events.

However, in some implementations, the one or more event producers may be limited to generating events that are context specific with respect to a particular event producer. Thus, an event consumer may not be aware of additional context information of the generated events. For example, a presentation system configured for generating one or more user interface (UI) views may not be aware of additional context information associated with an audit exception event generated by an audit system.

In order to provide the additional context information for one or more events generated by the one or more event producers, the various embodiments provide a data augmentation pipeline that seamlessly integrates and augments the one or more events with augmentation information before the one or more events are provided to the one or more event consumers. The augmentation information may include additional contexts that may be used by the various event consumers.

For example, the audit exception event including a device element identifier generated by the audit system may identify an inconsistency with a network router that identified by the device element identifier in the customer's or client's telecommunication network. However, the audit system may not be aware of the network topology data associated with a network router. The network topology data associated with the network router may include the network site, area, and/or region. To provide the network topology data associated with the network router, the data augmentation pipeline may further augment the event with the network topology data based on the device element identifier.

By providing a data augment pipeline that is configured to augment the one or more events with augmentation information rather than each individual event producers augmenting their own generated events with additional augmentation information, the one or more event producer may be decoupled from any additional systems, components, datastores that are required to augment the one or more events. Additional, examples, features, structures, characteristics, benefits, and/or advantages are further disclosed in detailed description that follows.

In the detailed description that follows, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly described herein.

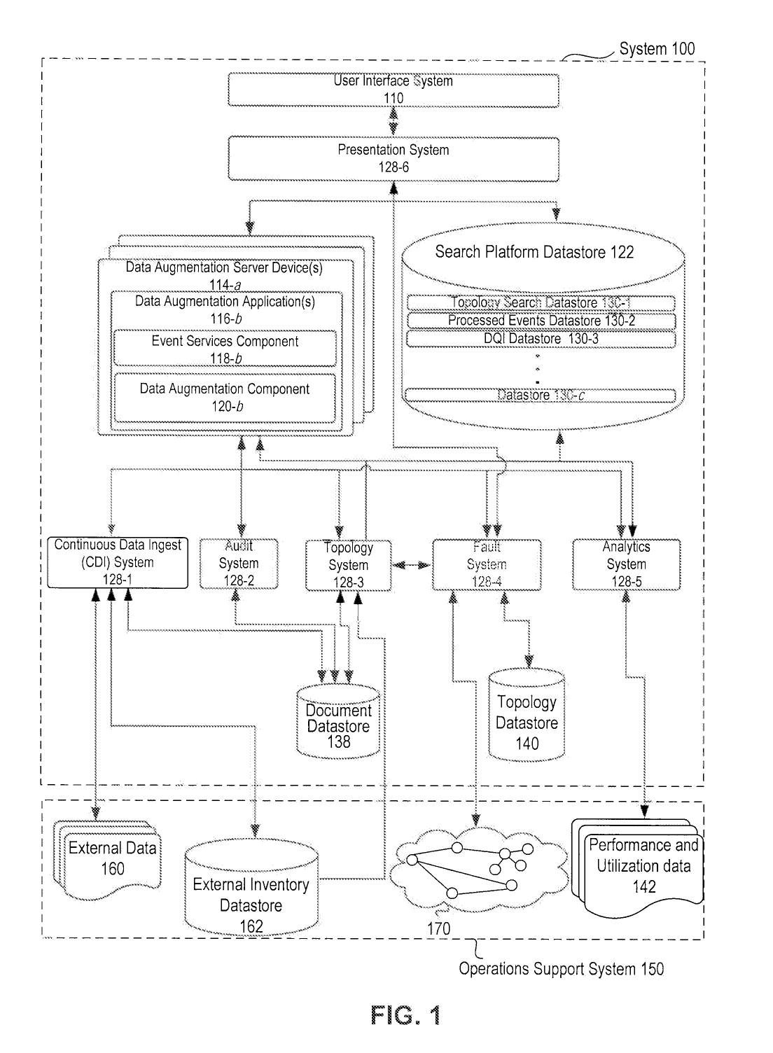

FIG. 1 illustrates a data augmentation system, according to an example embodiment.

One or more designators to the right of a reference number such as, for example, “a” and “b” and “c” and other similar designators are intended to be variables representing any positive integer. Thus, for example, if an implementation sets a value for a=4, then a complete set of elements 114-a may include elements 114-1, 114-2, 114-3, and 114-4.

The data augmentation system 100 may include one or more service systems 128-g. The one or more service systems 128-g may include continuous data ingest (CDI) system 128-1, audit system 128-2, topology system 128-3, fault system 128-4 operatively coupled to the topology system 128-3, analytics system 128-5, presentation system 128-6, and user interface system 110.

The data augmentation system 100 may further include one or more data augmentation server devices 114-a, which may be operatively coupled to the one or more service systems 128-g The data augmentation system 100 may also include a user interface (UI) system 110, which may be operatively coupled to the presentation system 128-6. The data augmentation system 100 may also include a search platform datastore 122, which may be operatively coupled to the one or more data augmentation server devices 114-a and one or more service systems 128-g (e.g., topology system 128-3, analytics system 128-5, etc.). The data augmentation system 100 may also include a document datastore 138, which may be operatively coupled to the CDI system 128-1, audit system 128-2, and topology system 128-3. The data augmentation system 100 may also include a topology datastore 140, which may be operatively coupled to the fault system 128-4.

The operations support system 150 may be representative of an operations support system of a customer or a client, such operations support system may include, external data 160, external inventory datastore 162, a telecommunications network 170 including one or more network monitoring devices or components (not shown) configured to generate one or more network alarms, and performance and utilization data 142.

The continuous data ingest (CDI) system 128-1 may include one or more server devices (not shown) executing one or more data ingestion applications (e.g., Apache Flume of The Apache Software Foundation located at Forest Hill, Md., etc.) arranged to automatically, periodically, continuously, on-demand, and/or real-time ingest data from one or more sources. The ingested data may include network topology data associated with the operations support system 150 for a customer's or client's telecommunications network 170.

The network topology data may include network device data (e.g., information relating to network devices or equipment such as routers, etc.), network device configuration data (e.g., information relating to configuration of network devices or equipment, etc.), region data (e.g., information relating to geographic region of a network device or equipment, etc.), site data (e.g., information relating to a network site or facility of a network device or equipment, etc.), vendor data (e.g., customer specific integration information, etc.), path data (e.g., information relating to network paths between network devices or equipment, etc.).

The various pieces of data or information may be represented as one or more network elements, where a network element may refer to a specific facility (e.g., a site, etc.), piece of equipment (e.g., a router, etc.), or logical grouping of equipment used in the network (e.g., an area, a region, etc.). A network element may also refer to features, functions, and capabilities that are provided by such facility or equipment. Each network element may also include several attributes.

Each network element may also be further identified by an element identifier to uniquely identify the network element, the type of network element, and associated information for that network element. By way of example, a site element identifier may identify a particular network site, a region element identifier may identify a particular region, a path element identifier may identify a particular network path, a device element identifier may identify a particular network device such as a network router, and/or the like.

The one or more sources of ingested data may include external data 160 (e.g., router configuration documents, Microsoft Excel and CSV documents, Microsoft Word documents, access vendor activation notices, network planning documents, etc.) and/or external inventory datastore 162 associated with the operations support system 150 of a telecommunications network of a customer or client. Additionally, the CDI System 128-1 may be further arranged to parse and analyze the ingested data from various sources into a network model (e.g., service information model (SIM), etc.) including one or more data objects representative of the one or more network elements and store the one or more data objects in a document datastore 138 operatively coupled to the CDI system 128-1.

The CDI system 128-1 may be configured generate one or more CDI events. The one or more CDI events may include CDI start event indicating the start of data ingestion, CDI stop event indicating the stop of data ingestion, and CDI process event. Each of the one or more CDI events may also event context and/or event type. The event context may include information identifying a current document being processed and the function or algorithm used to process the current document. The event type may identify the type of the event which may include CDI start event type, CDI stop event type, and/or CDI process event type.

The audit system 128-2 may include one or more server devices (not shown) executing one or more audit applications (not shown). The one or more audit applications may be generally arranged to automatically, periodically, continuously, on-demand, and/or in real-time analyze the ingested data stored in the document datastore 138 and determine inconsistencies or conflicts within the ingested data based on one or more audit rules. Additionally or alternatively, the audit system 128-2 may also be generally arranged to automatically analyze and determine inconsistences or conflicts, in response to receiving a CDI start event and/or CDI process event. The one or more audit rules may be configured to test or validate a specific attribute of one or more network elements between sources of ingested data. By way of example, an audit rule may be configured to validate a link speed attribute for a port on a router between the port on the router identified in the planning document and the same port identified in that router's configuration document.

The audit system 128-2 may be configured generate one or more audit exception events, which may include audit exception event, indicating a detected inconsistency or conflict with respect to a network element between sources of ingested data. The audit exception event may include event context and/or event type.

The event context may include one or more network element identifiers identifying one or more network elements within a customer's or client's operations support system 150 that was detected to be inconsistent or in conflict between sources of ingested data (e.g., a router element identifier that identifies a router, etc.). The event type may identify the type of the event, which may include audit exception event type.

The topology system 128-3 may include one or more server devices (not shown) executing one or more topology applications (not shown). The one or more topology applications may be generally arranged to automatically, periodically, continuously, on-demand, and/or in real-time analyze the ingested data stored in the document datastore 138 and/or external inventory data store 162 operatively coupled to the topology system 128-3 and determine the physical and/or logical network topology data, i.e., the one or more network elements and their interconnections and/or relationships between the one or more network elements based on the ingested data for a customer or client's telecommunications network 170. Additionally or alternatively, the audit system 128-2 may also be generally arranged to automatically determine network topologies, in response to receiving a CDI start event and/or CDI process event.

The topology system 128-3 may also be configured to provide and update network topology data stored in an indexed and searchable topology search datastore 130-1 of the search platform datastore 122. The topology system 128-3 may also provide and update network topology data to the fault system 128-4, which may be subsequently stored and/or updated in a topology datastore 140 by the fault system 128-4 operatively coupled to the topology datastore 140.

The topology system 128-3 may also be configured to generate one or more events, which may include topology start events indicating the start of a topology analysis, topology stop event indicating the stop of a topology analysis, and topology exception events indicating a detected inconsistency or conflict with respect to a network topology (e.g., a network path, etc.). The topology exception event may include event context and/or event type.

The event context may include network element identifier identifying a particular network element within a customer's or client's telecommunications network 170 that may be inconsistent or in conflict between sources of ingested data. The event type may identify the type of the event which may include topology start event type, topology stop event type, and topology exception event type.

The fault system 128-4 may include one or more server devices (not shown) executing one or more fault applications (not shown). The one or more fault applications may be generally arranged to automatically, periodically, continuously, on-demand, and/or in real-time monitor the telecommunications network 170 for one or more network alarms generated by one or more network monitoring devices or components indicating associated status updates or state changes for one or more network devices (e.g., failure status, warning status, unavailable status, etc.).

The fault system 128-4 may also be arranged to receive network topology data updates from the topology system 128-3 and update topology datastore 140. The one or more fault applications may be further arranged to determine one or more affected network elements based on the one or more network alarms generated by one or more network monitoring devices or components and/network topology data stored in the topology datastore 140.

The fault system 128-4 may also be configured to generate one or more events, which may include fault update events indicating an update of a status associated with a network element based on one or more affected network elements. The fault update event may include event context and/or event type.

The event context may include network element identifier identifying a particular network element within a customer's or client's telecommunications network 170 that may have an updated status. The event type may identify the type of the event which may include fault update event type.

The analytics system 128-5 may include one or more server devices (not shown) executing one or more analytics applications (not shown). The one or more analytics applications may be generally arranged to automatically, periodically, continuously, on-demand, and/or in real-time analyze the performance and utilization data 142 (e.g., available bandwidth, round trip time for a network packet, jitter time, etc.) associated with one or more network elements and determine one or more service level agreement (SLA) violations for one or more network elements based on one or more SLA rules. By way of example, the analytics system 128-5 may be configured to determine whether a SLA rule violation has occurred by comparing a measured bandwidth for a network port on a router with a specific minimum required bandwidth for that network pursuant to an SLA rule.

The analytics system 128-5 may also be configured to generate one or more events, which may include analytics exception events indicating a detected SLA rule violation with respect to a network element. The analytics exception event may include event context and/or event type.

The event context may include one or more network element identifiers identifying a particular network element within a customer's or client's telecommunications network 170 that may have violated an SLA rule. The event type may identify the type of the event, which may include analytics exception event type.

The data augmentation server devices 114-a may be generally configured to receive the one or more events generated by one or more event producers (e.g., one or more service systems 128-g, etc.), process the one or more received events and/or data associated with the one or more received events for augmentation based on one or more element identifiers associated with each event, and provide the processed event to one or more event consumers (e.g., one or more service systems 128-g, etc.).

Each data augmentation server device (e.g., data augmentation server device 114-1) may be configured to execute one or more data augmentation applications 116-b. Each data augmentation application (e.g., data augmentation applications 116-1) may also include an event services component (e.g., event services component 118-1) and a data augmentation component (e.g., data augmentation component 120-1).

The event services component (e.g., event services component 118-1) may generally configured to receive the one or more generated events, enqueue and dequeue the one or more received events, enqueue and dequeue one or more processed events, and search and/or update the platform datastore 122. The data augmentation component may also be configured to determine whether to augment the one or more receive events with data stored in the search platform datastore 122, when the augmentation information is available in the search platform datastore 122.

The presentation system 128-6 may be generally arranged to generate or render one or more user interface (UI) views (not shown) which may include telecommunications network topology of the telecommunications network 170. The telecommunications network topology may be represented as one or more network graphs comprising one or more network elements which may be represented as nodes and/or edges based on the network topology data stored in the search platform datastore 122. The presentation system 128-6 may be further arranged to automatically, periodically, continuously, on-demand, and/or in real-time update the one or more network graphs based on the one or more events processed by the one or more data augmentation applications 116-b.

The user interface (UI) system 110 may be generally arranged to provide and update the one or more generated or rendered UI views in accordance with application architecture (e.g., Flux application architecture by Facebook located at Menlo Park, Calif., etc.). The UI system 110 may be configured to receive user input or actions, update one or more datastores for storing UI related logic and data, and update the one or more generated or rendered UI views, in response to the updates to the one or more datastores for storing UI related logic and data. The user interface (UI) system 110 may also be configured to automatically, periodically, continuously, on-demand, and/or in real-time update generated or rendered UI views including one or more network graphs and provide one or more notifications regarding network status based on one or more events processed by the one or more data augmentation applications 116-b.

The search platform datastore 122 may be generally arranged to store one or more datastores 130-c, which may include topology search datastore 130-1 configured to store various network topology data, a processed events datastore 130-2 configured to store one or more processed events, and/or a data quality index/indicator (DQI) datastore 130-3 configured to store a reliability indicator of one or more network elements based on the number of inconsistencies and/or conflicts as indicated by one or more events (e.g., audit exception events, topology exception events, etc.).

It will be appreciated that the above configurations are merely representative embodiments of the data augmentation system 100 and/or operations support system 150. But further embodiments may include combinations and subcombinations of the one or more systems, components, datastores, and/or other features as desired for a given implementation.

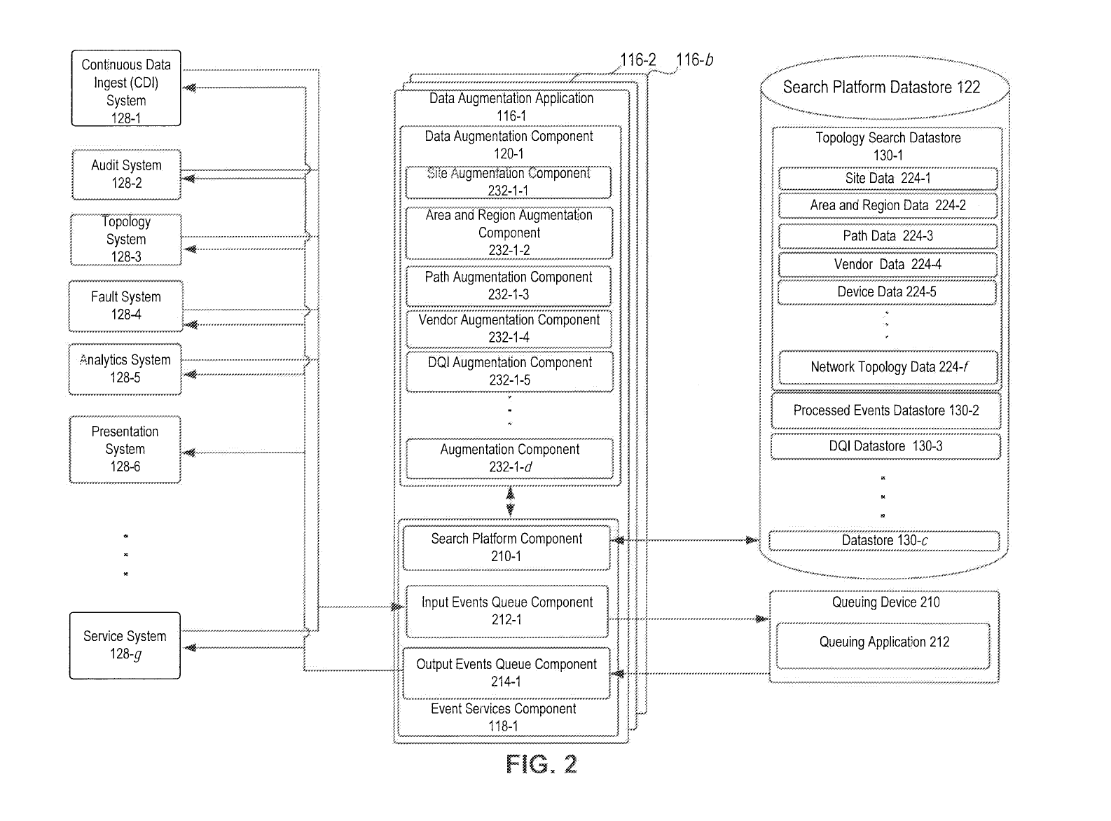

FIG. 2 illustrates a data augmentation application, search platform datastore, and queuing device, according to another example embodiment.

The topology search datastore 130-1 may further include a various network topology data 224-f representative of various aspects of network topology for a customer's or client's telecommunications network 170. The various network topology data 224-f may include site data 224-1, area and region data 224-2, path data 224-3, vendor data 224-4, device data 224-5, and/or any other network topology data 224-f that may be representative of various aspects of network topology.

The queuing device 210 may include a queuing application 212 configured to receive and enqueue one or more events received from input events queue component (e.g., input events queue component 212-1, etc.) and output events queue component (e.g., output events queue component 214-1, etc.). The queuing application 212 may also be configured to dequeue and provide one or more events to the input events queue component (e.g., input events queue component 212-1, etc.) and the output events queue component (e.g., output events queue component 214-1, etc.) to the one or more event consumers (e.g., one or more service systems 128-g, search platform datastore 130-2, etc.).

Each instance of the data augmentation component (e.g., data augmentation component 120-1, etc.) of a data augmentation application (e.g., data augmentation application 116-1, etc.) may include one or more augmentation components 232-1-d. The one or more augmentation components may include site augmentation component (e.g., site augmentation component 232-1-1, etc.), area and region augmentation component (e.g., area and region augmentation component 232-1-2, etc.), path augmentation component (e.g., path augmentation component 232-1-3, etc.), vendor augmentation component (e.g., vendor augmentation component 232-1-4, etc.), and/or data quality index/indicator (DQI) augmentation component (e.g., DQI augmentation component 232-1-5, etc.).

The site data 224-1 may include network site information for one or more network sites, where each network site may be identified by a site element identifier and may be associated with network site information. The network site information for a network site may include associated network area(s), site contact(s), network region(s), network device(s), and/or network path(s) for the network site.

The area and region data 224-2 include of network area and region information for one or more network areas and regions, where each network area and region may be identified by an area and region element identifier and may be associated with network area and region information. The network area and region information for a network site may include associated network site(s).

The path data 224-3 may include network path information for one or more network paths, where each network path may be identified by a path element identifier and may be associated with network path information. The network path information may include associated network site(s), associated customer specific integration information and associated site contact(s).

The vendor data 224-4 may include customer specific integration information for a customer or client, where the customer specific integration information may be identified by a vendor element identifier. The customer specific integration information may also include associated network path(s).

The device data 224-5 may be representative of network device information for one or more network devices, where each network device may be may be identified by a device element identifier and may be associated with network device information. The network device information may include one or more associated network sites.

The one or more augmentation components 232-1-d may be generally configured to receive one or more events from one or more service systems 128-g via an input events queue component (e.g., input events queue component 210-1, etc.), process the one or more received events for augmentation, and output the received event via the output events queue component (e.g., output events queue component, etc.).

The one or more augmentation components 232-1-d may also be configured to augment one or more events by transmitting a search query via a search platform component (e.g., search platform component 210-1, etc.) to query one or more datastores 130-c in a search platform datastore 122 for augmentation information associated with an event context of an event, the search query including at least a portion of the event context, receiving a search result via the search platform component (e.g., search platform component 210-1, etc.), in response to the transmitted search query, and attaching associated augmentation information to the received event, when the search results includes the associated augmentation information.

The one or more augmentation components 232-1-d may also be configured to augment data associated with one or more events based on event context of one or more events by transmitting an update via a search platform component (e.g., search platform component 210-1, etc.) to update the data that is associated with the event context and stored in the search platform datastore 122.

By way of example, the one or more augmentation components 232-1-d may be configured to augment data associated with one or more events by transmitting an update to the search platform component 210-1 to update the DQI data that is associated with an event context of one or more received events and stored in the search platform datastore 122, when the event context of the one or more received events includes a network element identifier identifying the associated DQI data and the event type of the received event is an exception event (e.g., a build exception event type, an audit exception event type, etc.).

The site augmentation component 232-1-1 may be configured to augment a received or previously processed event (e.g., a topology exception event, an audit exception event, etc.) based on an event context of the event. The event context may include a device element identifier (e.g., a router identifier that identifies a network router device, etc.) identifying a network device or a path element identifier identifying a network path. The site augmentation component 232-1-1 may be further configured to augment the received event by transmitting a search query via the search platform component 210-1 to query the topology search datastore 130-1 for site data 224-1, where the search query may include the device element identifier or path element identifier.

The site augmentation component 232-1-1 may further augment the received or previously processed event by receiving a search result via the search platform component 210-1, in response to the transmitted search query. After receiving the search result, the site augmentation component 232-1-1 may further augment the received or previously processed event by attaching the augmentation information to the event context of the event, when the search result includes the associated augmentation information. The attached augmentation information may include a site element identifier and/or associated network site information.

The area and region augmentation component 232-1-2 may be configured to augment a received or previously processed event (e.g., topology exception event, audit exception event, etc.) based on an event context of the event. The event context may include a site element identifier identifying a network site. The area and region augmentation component 232-1-2 may be further configured to augment the received or previously processed event by transmitting a search query via the search platform component 210-1 to query the topology search datastore 130-1 for area and region data 224-2, where the search query may include the site element identifier.

The area and region augmentation component 232-1-2 may further augment the received or previously processed event by receiving a search result via the search platform component 210-1, in response to the transmitted search query. After receiving the search result, the area and region augmentation component 232-1-2 may further augment the received or previously processed event by attaching associated augmentation information to the event context of the received event, when the search result includes the associated augmentation information. The associated augmentation information may include an area and region element identifier and/or associated area and region information.

The path augmentation component 232-1-3 may be configured to augment a received event or previously processed event (e.g., an audit exception event, topology exception event, etc.) based on an event context of the event. The event context may include a device element identifier identifying a network device or a site element identifier identifying a network site. The path augmentation component 232-1-3 may be further configured to augment the received event by transmitting a search query via the search platform component 210-1 to query the topology search datastore 130-1 for path data 224-1, where the search query may include the device element identifier or site element identifier.

The path augmentation component 232-1-3 may further augment the received or previously processed event by receiving a search result via the search platform component 210-1, in response to the transmitted search query. After receiving the search result, the path augmentation component 232-1-3 may further augment the received or previously processed event by attaching associated augmentation information to the event context of the event, when the search result includes the associated augmentation information. The associated augmentation information may include a path element identifier and/or associated network path information.

The vendor augmentation component 232-1-4 may be configured to augment a received or previously processed event (e.g., a fault update event, etc.) based on an event context of the event. The event context may include, a path element identifier identifying a network path. The path augmentation component 232-1-4 may be further configured to augment the received or previously processed event by transmitting a search query via the search platform component 210-1 to query the topology search datastore 130-1 for vendor data 224-1, where the search query may include the path element identifier.

The vendor augmentation component 232-1-4 may further augment the received or previously processed event by receiving a search result via the search platform component 210-1, in response to the transmitted search query. After receiving the search result, the vendor augmentation component 232-1-4 may further augment the received or previously processed event by attaching associated augmentation information to the event context of the event, when the search result includes the associated augmentation information. The associated augmentation information may include a vendor element identifier and/or associated customer specific integration information.

The DQI augmentation component 232-1-5 may be configured to augment data associated the event context and/or event type. Such augmentation may be performed by transmitting an update to the search platform component 210-1 to update data that is stored in one or more datastores 130-c of the search platform datastore 122 and associated with the event context and/or event type of the received or previously processed event.

By way of example, the DQI augmentation component 232-1-5 may augment a number of audit exceptions associated with a network path identified by a path element identifier. The DQI augmentation component 232-1-5 may perform the augmentation by transmitting an update to the search platform component 210-1 to increment the number of audit exception associated with the network path identified by the path element identifier. The DQI augmentation component 232-1-5 may transmit the update to the search platform component 210-1, when the event type is an audit exception event type and the event context includes the path element identifier identifying the network path having an associated audit exception.

By way of another example, the DQI augmentation component 232-1-5 may augment a number of topology exceptions associated with a network path identified by a path element identifier. The DQI augmentation component 232-1-5 may perform the augmentation by transmitting an update to the search platform component 210-1 to increment the number of topology exceptions for the network path identified by a path element identifier. The DQI augmentation component 232-1-5 may transmit the update to the search platform component 210-1, when the event type of the received or previously processed event is a topology exception event and the event context includes the path element identifier identifying the network path having an associated topology exception.

Each instance of the event service component (e.g., event service component 118-1, etc.) may include a search platform component (e.g., search platform component 210-1, etc.), an input events queue component (e.g., input events queue component 212-1, etc.), and/or an output events queue component (e.g., output events queue component 214-1, etc.).

The search platform component (e.g., search platform component 210-1, etc.) may be configured to receive one or more search queries from one or more respective augmentation components (e.g., augmentation components 232-1-d, etc.) to search the search platform datastore 122 and provide search results to the respective augmentation components (e.g., augmentation components 232-1-d, etc.) based on the one or more search queries. The one or more search queries may include at least a portion of the one or more event contexts. Additionally, the search platform component (e.g., search platform component 210-1, etc.) may also be configured to receive updates requests to update data stored in the search platform datastore 122 associated with at least a proton of the event context (e.g., path element identifier, etc.) and update the associated data.

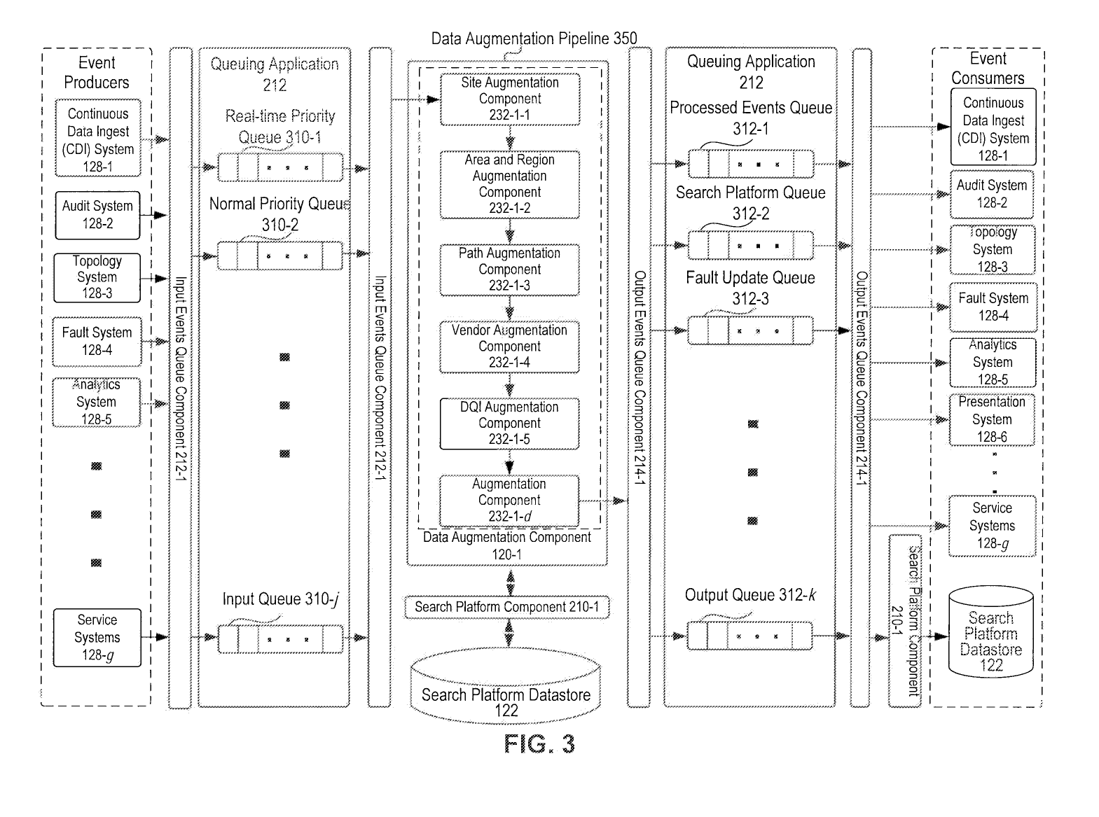

The input events queue component (e.g., input events queue component 212-1, etc.) may be configured to receive one or more events from one or more event producers (e.g., one or more service systems 128-g, etc.) and enqueue the one or more received events into one or more input queues managed by queuing device 210 and queuing application 212 further discussed with respect to FIG. 3. Additionally, the input events queue component (e.g., input events queue component 212-1, etc.) may also be configured to dequeue the one or more received events enqueued in the one or more input queues managed by queuing device 210 and queuing application 212 and provide the received event to the data augmentation component (e.g., data augmentation component 120-1, etc.).

The output events queue component (e.g., output events queue component 214-1, etc.) may be configured to receive one or more processed events from the data augmentation component (e.g., data augmentation component 120-1, etc.) and enqueue the one or more processed events into one or more output queues managed by queuing device 210 and queuing application 212 further discussed with respect to FIG. 3. Additionally, the output events queue component (e.g., output events queue component 214-1, etc.) may also be configured to dequeue the one or more processed events enqueued in the one or more output queues managed by queuing device 210 and queuing application 212 and provide the processed events to the one or more event consumers (e.g., one or more service systems 128-g, etc.).

It may be appreciated that in implementations that may include multiple data augmentation applications, each data augmentation application (e.g., data augmentation application 116-1, 116-2, 116-3, etc.) may be similarly configured and may include a data augmentation component. The data augmentation component (e.g., data augmentation component 120-1, etc.) may further be configured to include any number of the one or more of the augmentation components 232-b-d configured to receive, process, and output one or more processed events contemporaneously or simultaneously with respect to other data augmentation applications.

Additionally, each data augmentation application (e.g., data augmentation application 116-1, 116-2, 116-3, etc.) may also include similarly configured event service component (e.g., event service component 118-1, 118-2, 118-3, etc.). Each event services component may further include a similarly configured search platform component (e.g., search platform component 210-1, 210-2, 210-3, etc.) for searching and/or updating the search platform datastore 122. Furthermore, each event services component may further include a similarly configured output events queue component (e.g., output events queue component 214-1, 214-2, 214-3, etc.) and input events queue component (e.g., input events queue component 212-1, 212-2, 212-3, etc.) for managing the enqueuing and dequeuing of one more events into the queuing device 210.

It will be appreciated that the above configurations are merely representative embodiments of the one or more service systems 128-g, data augmentation applications 116-b, search platform datastore 122, and/or queuing device 210. But further embodiments may include combinations and subcombinations of the one or more systems, components, datastores, and/or other features as desired for a given implementation.

FIG. 3 illustrates the queuing application and the data augmentation pipeline according to an example embodiment.

As previously discussed, the queuing application 212 may include one or more input queues 310-j configured to store one or more events generated by one or more event producers (e.g., one or more service systems 128-g, etc.). The one or more input queues 310-j may include a real-time priority queue 310-1 and/or a normal priority queue 310-2.

The input events queue component 212-1 may be configured to receive one or more events from one or more vent producers and enqueue the one or more received events into an input queue in a queuing sequence. The queuing sequence may be determined based on the order the events are received by an input events queue component (e.g., input events queue component 212-1, etc.). For example, events that are received first by an input events queue component (e.g., input events queue component 212-1, etc.) with respect to other events received by the input events queue component (e.g., input events queue component 212-1, etc.) may be enqueued first.

Additionally or alternatively, in implementations that may include multiple input events queue components (e.g., input events queue component 212-1, 212-2, 212-3, etc.), the queuing sequence of the one or more events may be determined based on the order the events are received with respect to one or more input events queue components.

The input events queue component 212-1 may also be configured to receive one or more events and enqueue one or more events into an input queue based on the event type. By way of example, input events queue component 212-1 may be configured to receive an event and enqueue the event in the real-time priority queue 212-1, when the event type indicates that the event is a fault update event. The input events queue component 212-1 may also be configured to receive an event and enqueue the event in the normal priority queue 212-2, when the event type indicates that the event is an audit exception event. The input events queue component 212-1 may be further configured to receive an event and enqueue the event in the normal priority queue 212-2, when the event type indicates that the event is not a fault update event.

The data augmentation component 120-1 may be configured to request the input event queue component 212-1 to dequeue one or more previously enqueued event from the one or more input queues 310-j and receive the one or more dequeued events for augmentation. The input events queue component 212-1 may also be configured to dequeue one or more events from the one or more input queues 310-j based on a ranking or classification of the input queues 310-j, in response to request to dequeue one or more previously enqueued event.

The dequeuing of events based on ranking may enable the one or more events enqueued in a higher ranked queue to be dequeued for augmentation before one or more events in a lower ranked queue are dequeued for augmentation. By way of example, the real-time priority queue 310-1 may be configured as a higher ranked input queue than the normal priority queue 310-2, and as such, the input events queue component 212-1 may be configured to dequeue one or more previously enqueued events in the real-time priority queue 310-1, before dequeuing one or more enqueued events from the normal priority queue 310-2.

The data augmentation component 120-1 may include at least a portion of the data augmentation pipeline 350, which may further include, one or more augmentation components 232-1-d. The one or more augmentation components 232-1-d may be arranged in a sequence as illustrated in FIG. 3 and process the one or more received events in the sequence as illustrated. The sequence may also be determined based on relationship and associations between one or more network topology data 224-f stored in the topology datastore 130-1.

In implementations where there is more than one data augmentation application (e.g., data augmentation application 116-1, 116-2, 116-3 etc.) and each operatively coupled to the queuing application 212 via their respective input events queue component (e.g., input events queue component 212-1, 212-2, 212-3, etc.), each data augmentation component (e.g., data augmentation component 120-1, 120-2, 120-3 etc.) may be configured to process events in a particular input queue. By way of example, data augmentation component 120-1 may be configured to process events queued in the real-time priority queue 310-1, while data augmentation component 120-2 (not shown) may be configured to process events queued in the normal priority queue 310-2 (not shown).

The site augmentation component 232-1-1 of the data augmentation pipeline 350 may be configured to be the first augmentation component to receive a dequeued event and thus, first to process the dequeued event for augmentation in the data augmentation pipeline 350. After processing by the site augmentation component 232-1-1, the processed event, which may or may not be augmented, may be further provided to the next augmentation component, e.g., the area and region augmentation component 232-1-2 as illustrated in FIG. 3 for further processing.

The area and region augmentation component 232-1-2 may further process the previously processed event for further augmentation, based on the event context. The event context may include any previously augmented information. After processing by the area and region augmentation component 232-1-2, the area and region augmentation component 232-1-2 may provide the further processed event to the next augmentation component, e.g., the path augmentation component 232-1-3 for further processing. It may be appreciated that the processing of the event may continue through the data augmentation pipeline 350 until one or more remaining augmentation components (e.g., vendor augmentation component 232-1-4, DQI augmentation component, 232-1-5, etc.) in the data augmentation pipeline 350 have processed the event. Thus, in the data augmentation pipeline 350, an event may be processed by some or even all augmentation components 232-1-d components for augmentation before the event is provided to the output events queue component 214-1 for queuing in one or more output queues.

As previously discussed, the one or more data augmentation components 232-1-d may be further configured to augment the one or more events. The augmentation may be performed by transmitting one or more search queries via search platform component 210-1 to the search platform datastore 122 for augmentation information to attach to the one or more events and/or transmit one or more updates to update the information stored in the platform datastore 122.

After the one or more augmentation components 232-1-d processing the one or more events for augmentation, the data augmentation component 120-1 may be configured to provide the one or more processed events, which may or may not be augmented by the one or more augmentation components 232-1-d, to the output events queue component 214-1 for enqueuing. The output events queue component 214-1 may be configured to enqueue the one or more processed events into the one or more output queues 312-k of the queuing application 212.

The data augmentation component 120-1 may be further configured to provide the one or more processed events to the output events queue component 214-1 for enqueuing in one or more output queues 312-k, in the order the one or more events were dequeued and received from the input queues 310-j. This ordering may ensure that the one or more processed events is enqueued in one or more output queues (e.g., process events queue 312-1, search platform queue 312-2, fault update queue 312-3, etc.) in the same order as the events are enqueued in the input queues 312-j (e.g., real-time priority queue 310-1, normal priority queue 310-2, etc.).

The output events queue component 214-1 may also be configured to enqueue one or more processed events into the one or more output queues 312-k, where the same processed events may be duplicated and enqueued into the one or more output queues 312-k for the one or more event consumers. The one or more output queues 312-k may include a processed events queue 312-1, a search platform queue 312-2, fault update queue 312-3, and/or the like.

The one or more event consumers may include one or more service systems 128-g. The one or more service systems 128-g may be configured to consume one or more events by requesting the output event queue component 214-1 to dequeue or retrieve one or more previously processed events and receive the one or more previously enqueued processed events. It may be appreciated that each of the one or more event consumers may also be configured to consume the one or more events at a specific rate (e.g., automatically, periodically, continuously, on-demand, and/or in real-time).

Additionally or alternatively, instead of requesting the output event queue component 214-1 to dequeue or retrieve the one or more previously processed events, the output events queue component 214-1 may be configured to automatically, periodically, continuously, on-demand, and/or in real-time, provide or broadcast the one or more processed events to some or all of the event consumers (e.g., one or more service systems 128-g, search platform datastore 122, etc.) in the same order as the events are enqueued in the input queues 312-j (e.g., real-time priority queue 310-1, normal priority queue 310-2, etc.).

The one or more output queues 312-k may be associated with or subscribed by one or more specific event consumers, so that specific event consumers may be configured to request to dequeue, retrieve, or otherwise receive processed events. By way of example, processed events queue 312-1 may be associated with the CDI system 132-1, audit system 128-2, topology system 128-3, fault system 128-4, analytics system 128-5 and as such, the CDI system 132-1, audit system 128-2, topology system 128-3, fault system 128-4, analytics system 128-5 may subscribe to the processed events queue 312-1 via the output events queue component 214-1 and receive processed events from the processed events queue 312-1.

Continuing with the above example, the search platform queue 312-2 may be associated with or subscribed by the search platform datastore 122. The search platform datastore 122 may subscribe to the processed events queue 312-1 to receive processed events from the search platform queue 312-2. The received processed events may be further for stored and indexed in the processed events datastore 130-2 of the search platform datastore 122.

Further continuing with the above example, the presentation system 128-6 may be associated with or subscribed by the fault update queue 312-3, and as such, may subscribe to the fault update queue 312-3 via the output events queue component 214-1 to receive processed events from the fault update queue 312-3. The received processed events may be further processed for visual or graphical presentation by the presentation system 128-6 and/or UI system 110.

It will be appreciated that the above configurations are merely representative embodiments of the one or more event producers, one or more event consumers, queuing application 212, data augmentation pipeline 350. But further embodiments may include combinations and subcombinations of the one or more systems, components, datastores, and/or other features as desired for a given implementation.

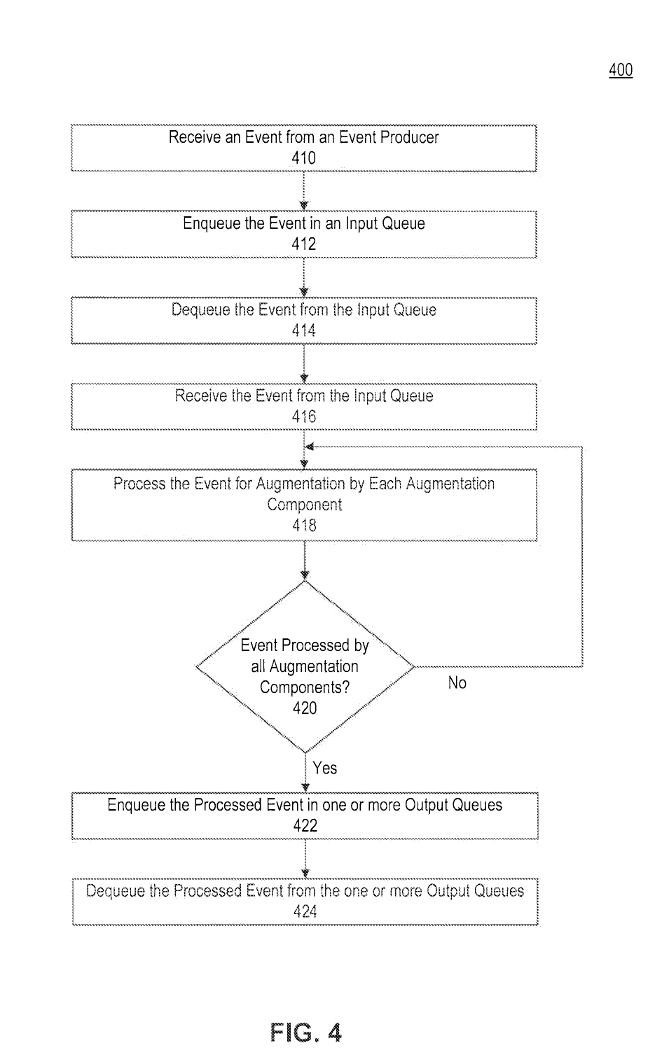

FIG. 4 illustrates a flowchart of the data augmentation system for processing an event via a data augmentation pipeline, according to an example embodiment.

The method 400 may begin at step 410, where an input events queue component may receive an event from an event producer. For example, the input events queue component 212-1 may receive an audit exception event generated by the audit system 128-2. The audit exception event may include an event context and event type. The event context may include a device element identifier and the event type may identify the event as an audit exception event.

Additionally or alternatively, the input events queue component 212-1 may also receive a topology exception event generated by the topology system 128-3. The topology exception event may include an event context and/or event type. The event context may include a site element identifier or path element identifier and the event type may identify the event as a topology exception event.

The input events queue component 212-1 may also receive a fault update event generated by the fault system 128-4. The fault update event may include an event context and event type. The event context may include a path element identifier and the event type may identify the event as a fault update event.

The input events queue component 212-1 may also receive an analytics exception event generated by the analytics system 128-5. The analytics exception event may include an event context and an event type. The event context may include a path element identifier and the event type may identify the event as an analytics exception event.

At step 412, an input events queue component may enqueue the event in an input queue. For example, the input events queue component 212-1 may enqueue the audit exception event, the topology exception event, the analytics exception event in a normal priority queue 310-2, and enqueue the fault update event in a real-time priority queue 310-1.

At step 414, an input events queue component may dequeue the event from an input queue. For example, the input events queue component 212-1 may dequeue the audit exception event, the topology exception event, the analytics exception event from a normal priority queue 310-2, and dequeue the fault update event from a real-time priority queue 310-1.

Additionally or alternatively, the input events queue component 212-1 may dequeue the fault update event from a real-time priority queue 310-1 before dequeuing any events from the normal priority queue 310-2, when the real-time priority queue 310-1 is a higher ranked queue than the normal priority queue 310-2.

At step 416, the data augmentation pipeline may receive the event from the input queue. For example, the data augmentation pipeline 350 may receive the audit exception event, the topology exception event, the analytics exception event from a normal priority queue 310-2, and/or receive the fault update event from a real-time priority queue 310-1.

At step 418, the data augmentation pipeline may process the event for augmentation by each augmentation component. For example, one or more augmentation components 232-1-d of the data augmentation pipeline 350 may process the events (e.g., audit exception event, the topology exception event, the analytics exception event, the fault update event or any other event) for augmentation by transmitting a search query to the search platform component 210-1. The search query may request the search platform component 210-1 to search for augmentation information associated with the event context and/or the event type in one or more datastores 130-c of the search platform datastore 122. The search query may include at least a portion of the event context and/or the event type. In response to the search query, one or more augmentation components 232-1-d may receive search results from the search platform component 210-1. The one or more augmentation components 232-1-d may also attach the associated augmentation information to the event context of the respective event, such as when the respective search results include the associated augmentation information.

In addition to or alternative to the above example, the one or more augmentation component 232-1-d may process the audit exception event, the topology exception event, the analytics exception event, the fault update event or any other event for augmentation by transmitting an update to the search platform component 210-1 to update data associated with event context based on the event context and/or the event type.

In the example with respect to the audit exception event, the site augmentation component 232-1-1 may process the audit exception event by transmitting a search query to the search platform component 210-1 to search the search platform datastore 122 for augmentation information associated with the device element identifier. In this example, the search query may include the device element identifier. In response to the search query, the site augmentation component 232-1-1 may receive search results from the search platform component 210-1. When the search results include associated augmentation information, the site augmentation component 232-1-1 may attach the associated augmentation information to the event context of the audit exception event. In this example, the associated augmentation information may include a site element identifier.

In the example with respect to the topology exception event, the site augmentation component 232-1-1 may process the topology exception event by transmitting a search query to search platform component 210-1 to search the search platform datastore 122 for augmentation information associated with a site element identifier or a path element identifier. In this example, the search query may include the site element identifier or the path element identifier. In response to the search query, the site augmentation component 232-1-1 may receive search results from the search platform component 210-1. When the search results include associated augmentation information, the site augmentation component 232-1-1 may further attach the associated augmentation information to the event context of the topology exception event. In this example, the associated augmentation information may include the site contact.

In the example with respect to the fault update event or the analytics exception event, the vendor augmentation component 232-1-4 may process the fault update event by transmitting a search query to search platform component 210-1 to search the search platform datastore 122 for augmentation information associated with the path element identifier in the respective event context. In response to the respective search query, the vendor augmentation component 232-1-4 may receive search results from the search platform component 210-1. When the respective search results include associated augmentation information, the vendor augmentation component 232-1-4 may attach the associated augmentation information to the respective event context of the fault update event or the analytics exception event. In this example, the associated augmentation information may include the vendor element identifier.

At step 420, the data augmentation pipeline may determine whether the event has been processed by all augmentation components. If yes, then the method 400 proceeds to step 422. If no, then the method 400 proceeds to step 418. For example, the data augmentation pipeline 350 may determine whether the event has been processed by all of the one or more augmentation components 232-1-d in the data augmentation pipeline 350. If yes, then the method 400 proceeds to step 422. If no, then the method 400 proceeds to step 418, where the event provided to one or more augmentation components 232-1-d within the data augmentation pipeline 350 for further processing.

In the example with respect to the audit exception event, after augmentation by the site augmentation component 232-1-1 with the site element identifier, the area and region augmentation component 232-1-2 may further process the audit exception event. To further process the audit exception event, the area and region augmentation component 232-1-2 may transmit a search query to the search platform component 210-1 to search the search platform datastore 122 for additional augmentation information associated with the previously attached site element identifier. In this example, the search query may include the previously attached site element identifier. In response to the search query, the area and region augmentation component 232-1-2 may receive search results from the search platform component 210-1. When the search results include associated additional augmentation information, the area and region augmentation component 232-1-2 may further attach the associated additional augmentation information to the event context of the audit exception event. In this example, the associated additional augmentation information may include the area and region information.

In addition or alternative to the above example and with respect to the audit exception event, after augmentation by the site augmentation component 232-1-1 with the site element identifier, the path augmentation component 232-1-3 may further process the audit exception event. To further process the audit exception event, path augmentation component 232-1-3 may transmit a search query to the search platform component 210-1 to search the search platform datastore 122 for additional augmentation information associated with the previously attached site element identifier. In this example, the search query may include the previously attached site element identifier. In response to the search query, the path augmentation component 232-1-3 may receive search results from the search platform component 210-1. When the search results include associated additional augmentation information, the path augmentation component 232-1-3 may further attach the additional augmentation information to the event context of the audit exception event. In this example, the associated additional augmentation information may include the path element identifier.

In addition to the above example and with respect to the audit exception event, after augmenting the audit exception event with the path element identifier, the vendor augmentation component 232-1-4 may further process the audit exception event. To further process the audit exception event, the vendor augmentation component 232-1-4 may transmit a search query to the search platform component 210-1 to search the search platform datastore 122 for additional augmentation information associated with the previously attached path element identifier. In this example, the search query may include the previously attached path element identifier. In response to the search query, the path augmentation component 232-1-3 may receive search results from the search platform component 210-1. When the search results include associated additional augmentation information, the vendor augmentation component 232-1-4 may further attach the additional augmentation information to the event context of the audit exception event. In this example, the associated additional augmentation information may include the vendor element identifier.

In addition to the above examples and with respect to the audit exception event, after augmenting the event context of the audit exception event by the vendor augmentation component 232-1-4 with the path element identifier or after augmenting the event context of the audit exception event with the vendor element identifier, the DQI augmentation component 232-1-5 may process the audit exception event. To further process the audit exception event, the DQI augmentation component 232-1-5 may transmit an update to the search platform component 210-1 to increment number of audit exceptions associated with a network path identified by the path element identifier.

In the example with respect to the topology exception event, after augmenting the topology exception event with the site element identifier, the area and region augmentation component 232-1-2 may further process the topology exception event. To further process the topology exception event, the area and region augmentation component 232-1-2 may transmit a search query to the search platform component 210-1 to search the search platform datastore 122 for additional augmentation information associated with the site element identifier. In this example, the search query may include the site element identifier. In response to the search query, the area and region augmentation component 232-1-2 may receive search results from the search platform component 210-1. When the search results include associated additional augmentation information, the area and region augmentation component 232-1-2 may further attach the additional augmentation information to the event context of the topology exception event. In this example, the associated additional augmentation information may include the area and region information.

At step 422, the output events queue component may enqueue the processed event in one or more output queues. For example, after an event (e.g., the audit exception event, the topology exception event, the analytics exception event, the fault update event or any other event) has been processed by all of the one or more augmentation components 232-1-d in the data augmentation pipeline 350, the output events queue component 214-1 may then enqueue the processed event (e.g., the processed audit exception event, the processed topology exception event, the processed analytics exception event, the processed fault update event, or any other processed event). The processed event may be enqueued in the processed events queue 312-1, search platform queue 312-2, fault update queue 312-3, and/or any other output queues 312-k.

At step 424, the output events queue component may dequeue the processed event from the one or more output queues and the method 400 may end. For example, the output events queue component 214-1 may dequeue the processed event (e.g., processed audit exception event, the topology exception event, the analytics exception event, the fault update event or any other processed event) from the one or more output queues 312-k (e.g., processed events queue 312-1, search platform queue 312-2, fault update queue 312-3, and/or any other output queues 312-k). The output events queue component 214-1 may further provide the one or more processed events to the one or more event consumers (e.g., one or more service systems 128-g, search platform datastore 122, or any other event consumers).

It will be appreciated that the above configurations are merely representative embodiments of a flow chart for the data augmentations system 100. But it is to be understood and appreciated that the methodologies are not limited by the order of steps as illustrated and described. Thus, in further embodiments some steps may occur in a different order and/or concurrently with other steps.

### Example Computer System

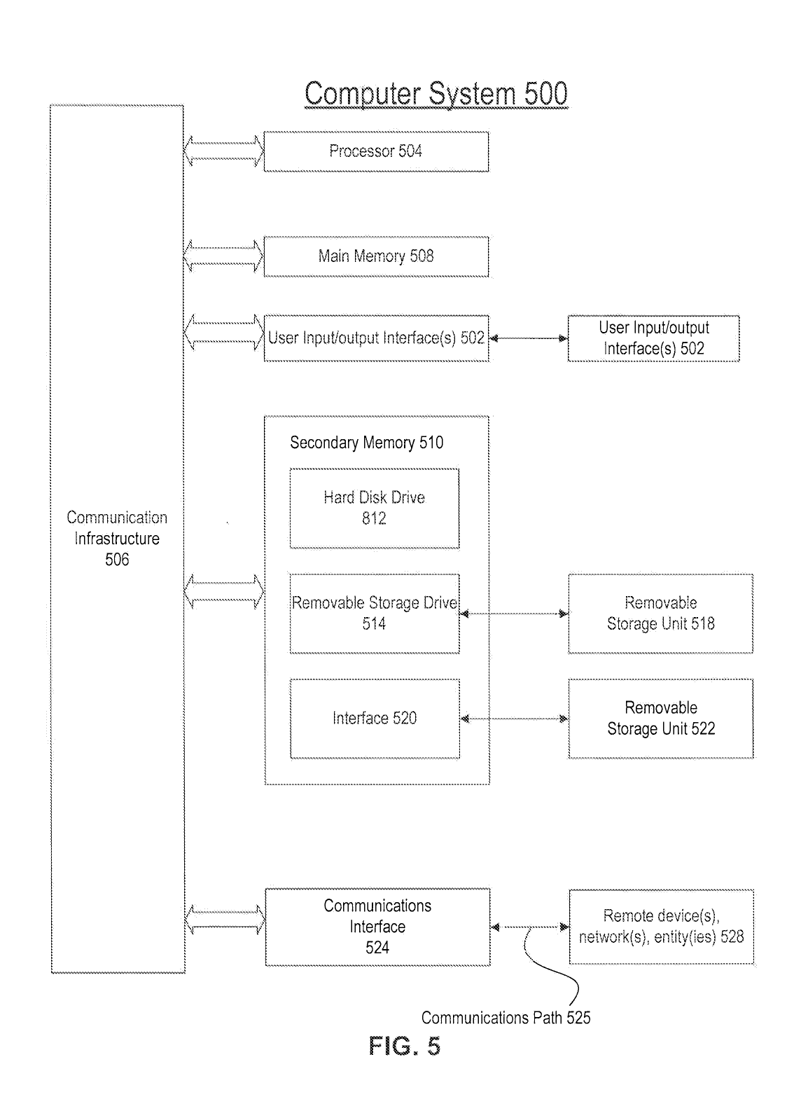

FIG. 5 is an example computing system useful for implementing various embodiments. Various embodiments can be implemented, for example, using one or more well-known computer systems, such as, one or more server devices (not shown) of the one or more service systems 128-g, one or more server devices (not shown) of the UI system 110, and/or one or more data augmentation server devices 114-a. Computer system 500 can be any well-known computer capable of performing the functions described herein, such as computers available from International Business Machines, Apple, Sun, HP, Dell, Sony, Toshiba, etc.

Computer system 500 includes one or more processors (also called central processing units, or CPUs), such as a processor 504. Processor 504 is connected to a communication infrastructure or bus 506.

One or more processors 504 may each be a graphics processing unit (GPU). In an embodiment, a GPU is a processor that is a specialized electronic circuit designed to rapidly process mathematically intensive applications on electronic devices. The GPU may have a highly parallel structure that is efficient for parallel processing of large blocks of data, such as mathematically intensive data common to computer graphics applications, images and videos.

Computer system 500 also includes user input/output device(s) 503, such as monitors, keyboards, pointing devices, etc., which communicate with communication infrastructure 506 through user input/output interface(s) 502.

Computer system 500 also includes a main or primary memory 508, such as random access memory (RAM). Main memory 508 may include one or more levels of cache. Main memory 508 has stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 includes a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 reads from and/or writes to removable storage unit 518 in a well-known manner.

According to an exemplary embodiment, secondary memory 510 may include other means, instrumentalities or other approaches for allowing computer programs and/or other instructions and/or data to be accessed by computer system 500. Such means, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 enables computer system 500 to communicate and interact with any combination of remote devices, remote networks, remote entities, etc. (individually and collectively referenced by reference number 528). For example, communication interface 524 may allow computer system 500 to communicate with remote devices 528 over communications path 526, which may be wired and/or wireless, and which may include any combination of LANs, WANs, the Internet, etc. Control logic and/or data may be transmitted to and from computer system 500 via communication path 526.

In an embodiment, a tangible apparatus or article of manufacture comprising a tangible computer useable or readable medium having control logic (software) stored thereon is also referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), causes such data processing devices to operate as described herein.

Based on the teachings contained in this disclosure, it will be apparent to persons skilled in the relevant art(s) how to make and use the invention using data processing devices, computer systems and/or computer architectures other than that shown in FIG. 5. In particular, embodiments may operate with software, hardware, and/or operating system implementations other than those described herein.

### CONCLUSION

It is to be appreciated that the Detailed Description section, and not the Brief Summary and Abstract sections, is intended to be used to interpret the claims. The Summary and Abstract sections may set forth one or more but not all exemplary embodiments of the invention as contemplated by the inventors, and thus, are not intended to limit the invention or the appended claims in any way

Identifiers, such as “(a),” “(b),” “(i),” “(ii),” etc., are sometimes used for different elements or steps. These identifiers are used for clarity and do not necessarily designate an order for the elements or steps.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

Additionally, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

The foregoing description of specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described embodiments, but should be defined only in accordance with the following claims and their equivalents.

What is claimed is:

1. A computer-implemented method, comprising:
receiving one or more events from one or more service systems, the one or more events including a first event, the first event including a first event context having an associated first element identifier;
processing the first event by a first augmentation component of a data augmentation pipeline for augmentation based on the first event context of the first event; and
enqueuing the first event into at least one output queue, after processing the first event by the data augmentation pipeline.

2. The computer-implemented method of claim 1, further comprising:
enqueuing each event of the one or more events into at least one input queue, after receiving the one or more events from the one or more service systems; and
dequeuing each event of the one or more events from the at least one input queue for the augmenting based on an order the one or more events were received for enqueuing into the at least one input queue.

3. The computer-implemented method of claim 2, wherein the processing of the first event by the first augmentation component further comprises:
transmitting a first search query to a search platform component, wherein the search query includes a first element identifier of the first event context;
receiving a first search result, in response to the transmitted first search query; and
attaching the first augmentation information to the first event context, when the first search result includes the first augmentation information, the first augmentation information including a second element identifier.

4. The computer-implemented method of claim 3, further comprising:
processing the first event by a second augmentation component of the data augmentation pipeline for augmentation based on the first event context of the first event.

5. The computer-implemented method of claim 4, wherein the processing of the first event by the second augmentation component further comprises:
transmitting a second search query to the search platform component, wherein the search query includes the second element identifier of the first event context;
receiving a second search result, in response to the transmitted second search query; and
attaching the second augmentation information to the first event context, when the first search result includes the second augmentation information.

6. The computer-implemented method of claim 2, wherein the at least one input queue comprises a real-time priority event queue and a normal priority event queue, and the dequeuing of each event further comprises dequeuing each received event from the real-time priority event queue for the augmenting before dequeuing from the normal priority event queue.

7. A computer-implemented method of claim 3, wherein the first event context includes a device element identifier, site element identifier, a path element identifier, a vendor element identifier, or any combination thereof.

8. A system, comprising:
at least one processor, and
a memory operatively coupled to the at least one processor, the memory comprising instructions that, when executed by the at least one processor, configures the at least one processor to:
receive one or more events from one or more service systems, each event comprising an event context;
process the one or more events by one or more augmentation components of a data augmentation pipeline for augmentation based on the event context of each event; and
enqueue the one or more processed events into one or more output queues.

9. The system claim 8, wherein the at least one processor is further configured to:
enqueue each event of the one or more events into at least one input queue, after receiving the one or more events from the one or more service systems; and
dequeue each event of the one or more events from the at least one input queue for the augmenting based on an order the one or more events were received for enqueuing into the at least one input queue.

10. The system of claim 8, wherein the one or more service systems includes at least one of: continuous data ingest system configured to ingest data from one or more sources, audit system configured to determine inconsistencies between the one or more sources of ingested data, topology system configured to determine the physical and/or logical network topology data, fault system configured to monitor a telecommunication network for one or more network alarms, and/or analytics system configured to determine service level agreement (SLA) rule violations.

11. The system of claim 8, wherein the one or more events includes at least one of: audit exception event indicating a detected inconsistency for a network element, topology exception event indicating a detected inconsistency or conflict with respect to a network topology, fault update event indicating an update of a status associated with a network element, and/or analytics exception event indicating a detected service level agreement (SLA) rule violation with respect to a network element.

12. The system of claim 8, wherein the one or more augmentation components includes at least one of: a site augmentation component configured to augment the one or more events with site data, area and region component configured to augment the one or more events with area and region data, path augmentation component configured to augment the one or more events with path data, and/or vendor augmentation component configured to augment the one or more events with vendor data.

13. The system of claim 12, wherein the one or more augmentation components comprise a data quality indicator (DQI) component configured to augment DQI data stored in the search platform datastore and associated with a path element identifier of an event context of an exception event.

14. The system of claim 8, wherein the one or more output queues includes a processed events queue, a search platform queue, and a fault update queue, and the at least one processor is further configured to dequeue the one or more processed events in the one or more output queues and provide the one or more processed events to one or more event consumers.

15. A tangible computer-readable device having instructions stored thereon that, when executed by at least one computing device, causes the at least one computing device to perform operations comprising:
receiving one or more events from one or more service systems, the one or more events including a first event, the first event including a first event context having an associated first element identifier;
processing the first event by a first augmentation component of a data augmentation pipeline for augmentation based on the first event context of the first event; and
enqueuing the first event into at least one output queue, after processing the first event by the data augmentation pipeline.

16. The computer-readable device of claim 15, the operations further comprising:
enqueuing each event of the one or more events into at least one input queue, after receiving the one or more events from the one or more service systems; and
dequeuing each event of the one or more events from the at least one input queue for the augmenting based on an order the one or more events were received for enqueuing into the at least one input queue.

17. The computer-readable device of claim 16, wherein the processing of the first event by the first augmentation component further comprises:
transmitting a first search query to a search platform component, wherein the search query includes a first element identifier of the first event context;
receiving a first search result, in response to the transmitted first search query; and
attaching the first augmentation information to the first event context, when the first search result includes the first augmentation information, the first augmentation information including a second element identifier.

18. The computer-readable device of claim 17, the operations further comprising:
processing the first event by a second augmentation component of the data augmentation pipeline for augmentation based on the first event context of the first event.

19. The computer-readable device of claim 18, wherein the processing of the first event by the second augmentation component further comprises:
transmitting a second search query to the search platform component, wherein the search query includes the second element identifier of the first event context;
receiving a second search result, in response to the transmitted second search query; and
attaching the second augmentation information to the first event context, when the first search result includes the second augmentation information.

20. The computer-readable device of claim 19, wherein
the first element identifier is a device element identifier,
the first event is an audit exception event,
the second element identifier is a site element identifier, and
the second augmentation information includes an area and region element identifier.
